(19) United States
(12) Patent Application Publication
(10) Pub. No.: US 2007/0180506 A1
(43) Pub. Date: Aug. 2, 2007

(54) Method of evaluating credentials of individuals and associated apparatus

(76) Inventor: Joyce A. Query, Cheswick, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/345,699

(22) Filed: Feb. 2, 2006

(51) Int. Cl. H04L 9/32

(52) U.S. Cl. 726/5

(57) ABSTRACT

A computerized method of authenticating credentials of an individual includes receiving credentials relating to the individual, obtaining from a third party authentication of said credentials, accepting or rejecting an individual based upon the authentication results and permitting remote access to credentials of approved or accepted individuals to confirm certification of the credentials by the authenticating agency. The accepted individual may be provided with indicia showing certification or approval by the authenticating agency. In another embodiment of the invention, third parties may be permitted access to the authenticating agency's website in order to enable them to obtain credentials on a number of accepted individuals with searches being conducted on any of a number of fields, such as individual name, occupation, geographic location and the like. Related computerized apparatus is provided.

### BACKGROUND OF THE INVENTION

1. Field of the Invention

The present invention relates to a method of authenticating credentials of an individual and if accepted due to favorable authentication, permitting the individual to communicate the acceptance by the authenticating agency to others with remote access to the credentials being permitted. The invention also relates to associated apparatus.

2. Description of the Prior Art

It has been known for many purposes such as pre-employment screening, acceptance into organizational membership, admission to institutions of higher learning and numerous other purposes to verify credentials provided by an individual in that context. Such evaluations and authentications typically are conducted on a one-to-one basis with the information being maintained in confidence by the recipient who did an authentication evaluation.

An increasing problem which has become more acute with the passage of time is the falsification of credentials by individuals and the inefficiency and relatively slow procedures employed to verify the authenticity of such credentials.

There has also been lacking any uniform recognized means for communicating the fact that the credentials have been verified.

There remains, therefore, a very real and substantial need for an improved system for rapidly and accurately evaluating the authenticity of an individual's credentials and permitting access to validated credentials.

### SUMMARY OF THE INVENTION

The present invention has met the above-described needs. The method of the present invention provides for computerized evaluation of credentials of an individual and if authenticity is confirmed, accepting the individual's credentials and authorizing the use of indicia by the individual indicating that the credentials have been authenticated as well as permitting remote access to the credentials of accepted individuals.

In one embodiment of the invention, the approved individual may be permitted to provide on its website an icon or other identifying indicia indicating that it has been approved by the authenticating agency. One accessing the website of the individual may click on the icon or other identifying indicia in order to cause the authenticated credentials of the individual to appear on the individual's website.

In another embodiment of the invention, the approved individual may be permitted to direct third parties to a website of the authenticating agency wherein the approval may be confirmed and access to the credentials of the individual may be obtained. Such access in the second embodiment may be in the form of a hyperlink from the accepted individual's website to the authorizing organization's website.

The apparatus of the present invention provides for authentication of an individual's credentials by employing a computer to receive credentials relating to the individual. The computer is structured to send inquiries requesting authentication of the credentials to information sources and receive responses to the inquiries followed by comparison within the computer of the responses with the credentials. The individual may then be provided with notice electronically or otherwise indicating whether the individual has been accepted or not.

The computer may have a database which stores information regarding an individual's credentials and the authentication responses with a comparison resulting in a determination as to whether the individual was or was not accepted.

In yet another embodiment of the invention, the method and apparatus may permit qualified individuals to have remote access to the authenticating agency's database for purposes of searching for individuals based upon selected credentials. As contrasted with the first two embodiments of the invention, the access may be such as to permit searching the entire database or certain selected groupings of individuals as contrasted with focusing on the credentials of a single individual. In the first two embodiments, the focus is on the individual initially and in the third embodiment, the focus may be either on an individual by name or credentials which form the basis of the search.

It is an object of the present invention to provide a method and associated apparatus for rapid authenticity evaluation of an individual's credentials and either acceptance or rejection of the individual on the basis of the results.

It is a further object of the present invention to provide accepted individuals with approval to employ indicia indicating that the authenticating organization has reviewed and approved the individual's credentials.

It is a further object of the present invention to permit an accepted individual to employ authenticating indicia indicating approval of the individual's credentials by an authenticating agency.

It is a further object of the present invention to permit an accepted individual to provide authenticating indicia on his website so as to admit a third party to have access to the authenticated credentials on said website or on another website, such as the authenticating agency's website, for reviewing the authenticated credentials.

It is yet another object of the present invention to permit third party remote access to the authenticating organization's database to review all accepted individual's credentials.

These and other objects of the invention will be more fully understood from the following description of the invention on reference to the illustrations appended hereto.

### BRIEF DESCRIPTION OF THE DRAWINGS

FIG. 1 is a schematic illustration of an embodiment of a method of the present invention employed in the authentication process.

FIG. 2 is a schematic illustration of a method of accessing the authenticating agency's database.

FIG. 3 is a schematic illustration of apparatus employable in connection with the present invention.

### DESCRIPTION OF THE PREFERRED EMBODIMENTS

As employed herein, the term “individual” means a natural person, a business entity, a non-profit organization, association, school or other entity.

As employed herein, the term “credentials” means factual information regarding the background of an individual or group of individuals.

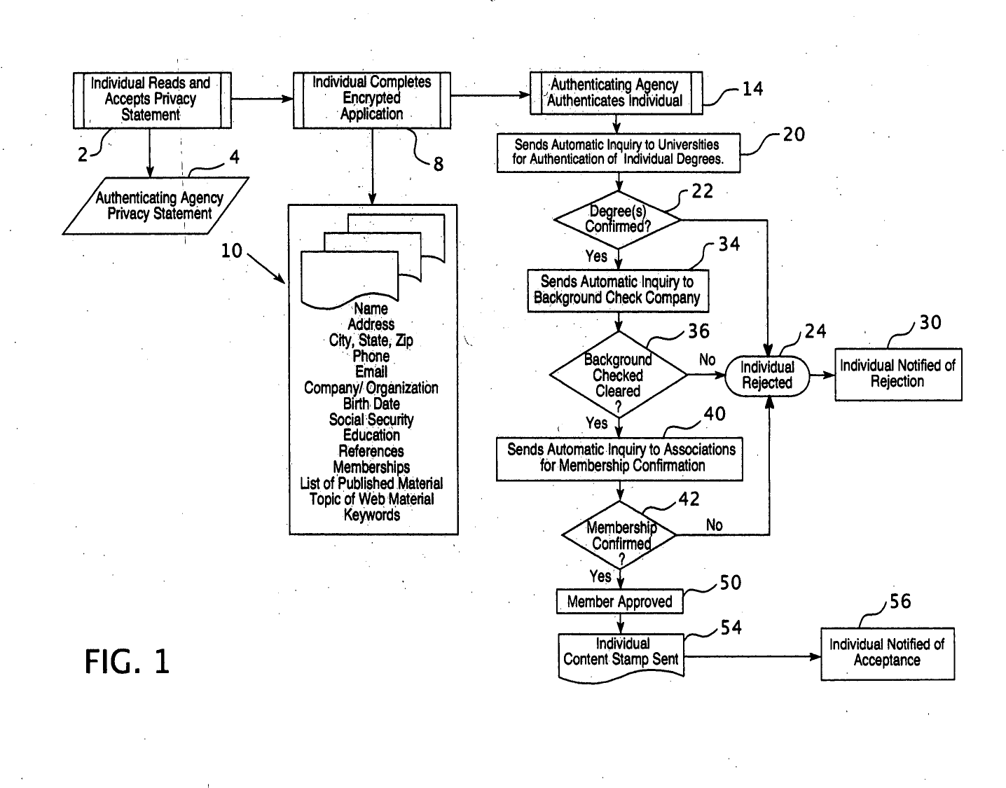

Referring to FIG. 1 and a preferred version of a first embodiment of the invention, the method may be initiated by having an individual review and accept 2 a privacy statement 4 which preferably provides assurance to the individual that information received by the authenticating agency will be maintained in confidence unless and until the individual has been accepted as a result of the credentials being approved. After agreement on the part of the individual to the privacy statement 4, the individual then completes the authenticating agency's application 8 which contains a great deal of background information 10 on the individual, such as the name, address, telephone number, e-mail address, company or organization, if applicable, date of birth, social security or other identifying number, education, personal references, membership lists of published material, topics of web material and key words for retrieval by searcher. These credentials are introduced into a database in the computer. The method then has the authenticating agency directly or through a third party send to various information sources 14 inquiries in order to attempt to authenticate information. All of this is preferably accomplished by computer so as to enhance speed of processing and efficiency of communication, while accomplishing the objective in an economical fashion. The addresses for the information sources may be stored on the computer database.

While for purposes of simplicity and clarity of disclosure the embodiment of FIG. 1 will provide certain examples of credentials being checked depending on the individual and context, a wide variety of credentials may be evaluated. The credentials may include, but not be limited to, at least one of the group consisting of education, professional licenses, memberships, publications, date of birth, employment history and criminal history.

In FIG. 1, the first credential being evaluated for authentication is education 20. If the degree has not been confirmed 22, the individual is rejected 24 and a notice to that effect 30 is sent to the individual. If the university credential has been authenticated 22, the background check is initiated 34. The background check result 36, if negative, will result in the individual being rejected 24 and a notice of the same 30 being sent. If both the university and background checks 20, 34 have been favorable in terms of authentication, an inquiry is sent to associations where a membership has been indicated 40 with the response 42. if negative, resulting in the individual being rejected 24 and the appropriate notice being sent 30 to the individual.

While the example in FIG. 1 shows sequential inquiry into university status, background and association membership, it will be appreciated that these may be determined in any sequence and, further, any other information which is to be authenticated could be processed in a similar fashion. A comparison of the credentials and the authenticating information received from third parties is made in the computer. If all of the inquiries result in authentication, the individual is approved 50 and authorization to indicate such approval 54 by a suitable graphic, such as an icon, which may be a stamp of approval, for example, or suitable words or both, is provided to the individual 56.

While emphasis has been placed herein on the approved individual placing indicia of the approval from the authenticating agency on a website, it will be appreciated that the invention is not so limited. For example, the indicia may be employed on hard copies, such as printed promotional materials, books, manuals and other uses where the authenticated credentials may be displayed or, in the alternative, merely the indicia presented as something in the nature of a seal of approval.

It will be appreciated that in setting up the standards for approval, the authenticating agency will determine how a given response it receives to an authenticating inquiry will be evaluated. For example, if an individual indicated that he or she had received a Bachelor of Science degree from the University of Maryland and if the feedback indicates that no such degree was awarded, this would be a clear ground for rejection. If, on the other hand, an individual indicated that he or she was a member of the American Society of Mechanical Engineers and the response from the Society indicated that while the individual did not have current membership, there was an approved application and membership would be issued in the near future, the standards established by the authenticating agency might well regard this as an authentication, even though the statement was not at that time literally correct. If all of the credentials with respect to which authentication has been sought are approved, the member/individual 50 is approved and provided with a notice of acceptance 56 and approval to display the authenticating agency's approved indicia, such as a stamp, in promotional materials and other items as well as on its website to confirm certification of the credentials.

In a preferred embodiment of the invention, a word, graphics or combination of indicia indicating approval by the authenticating agency may be displayed on promotional materials including a website of the individual. This information may provide the web address of the individual or authenticating agency wherein the third party can both confirm authenticity of the credentials and obtain a display of the credentials. In one embodiment, a third party accessing the individual's website might be hyperlinked to the authenticating agency's website to thereby obtain the information regarding authenticated credentials of the individual.

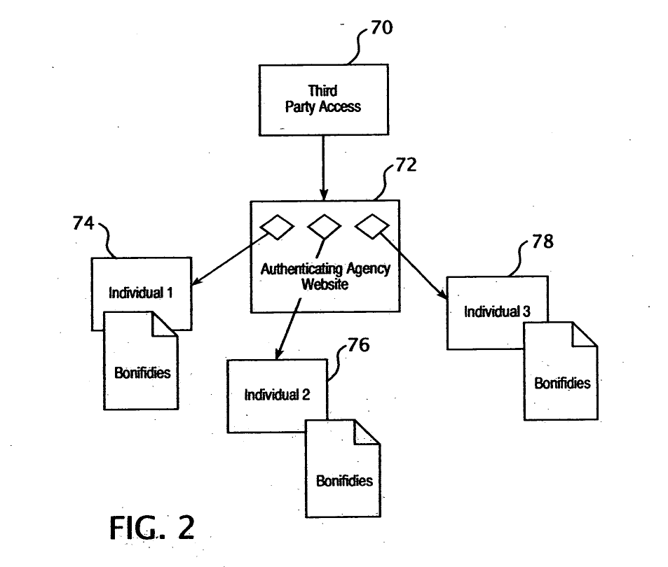

Referring to FIG. 2, there is shown a scenario wherein a third party 70 accessing the website of the authenticating agency 72. This may be accessed by direct remote access to the authenticating agency's web address. If desired, suitable security safekeeping procedures may be employed to make sure only authorized third parties are permitted to access the website. This permits the third party to access the credentials of individual 1(74) or individual 2(76) or individual 3(78) and all others who have consented to third party access. The term “Bonifidies” has been employed to indicate credentials.

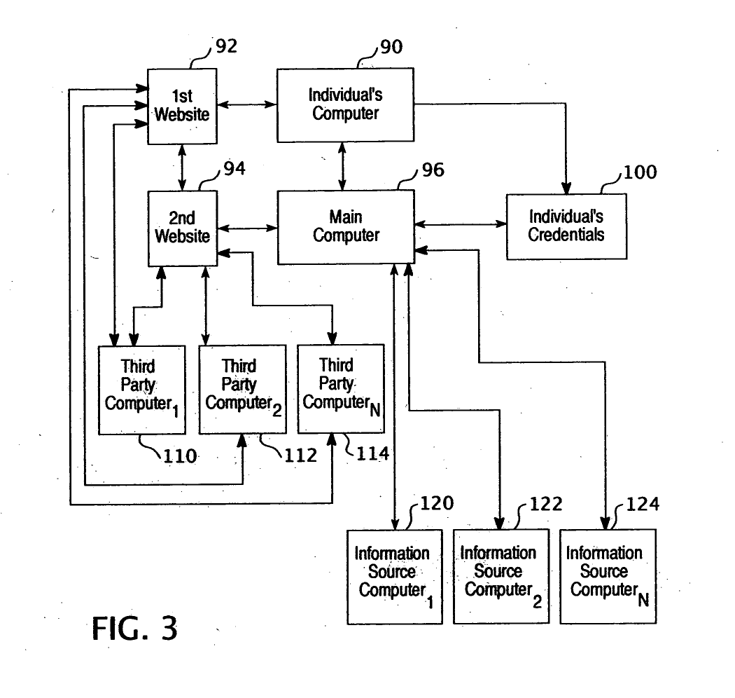

Referring to FIG. 3, there is shown apparatus usable in the present invention. An individual's computer 90 is operatively associated with the individual's 1st website 92, which, in turn, remotely accesses the authenticating agency or 2nd website 94. A main computer 96 is operatively associated with the second website 94 and receives individual's information 100 from the individual's computer 90 or through other means. In the form shown, a third party computer₁, 110, third party computer₂, 112, and third party computer_{N}. 114 are shown accessing the 2nd website 94 which will permit them to access the credentials of the individuals on second website 94. These may also access first website 92 directly to obtain an individual's credentials, if desired. In addition, the individual's 1^{st} website 92 may be hyperlinked to 2^{nd} website 94.

Upon receiving the individual's credentials 100 after receiving the individual executed privacy statement, the main computer 96 sends inquiries to information sources which, in the form shown, are information source₁ 120, information source₂ 122 and information source_{N} 124. The information received from the information sources, which are information source computer₁, 120, information source computer₂, 122, and information source computer_{N}, 124, are compared in the main computer 96 with the individual's credentials, which are stored in a database within main computer 96, which, in turn, issues an accepted or rejected message to the individual's computer 90.

Another feature of the invention is to permit duly authorized third parties to access the authenticating agency's website 94 for the purpose of viewing the authenticated credentials of a number of individuals who have been accepted by the authenticating agent and certified as having credentials which have been authenticated. In such a system, the third parties may have to have appropriate security identification, such as by access codes and identification numbers, in order to gain access to the website 94 and access may be provided to only the credentials of individuals who have consented to such third party access. Such access by third parties may be obtained in several manners. For example, the specific names of individuals could be the basis for a field of search. In the alternative, there could be searches performed on the basis of topics of interest, occupations or key words. These searches could be a way of selecting particular individuals from the database. For example, if one wanted to locate orthopedic surgeons who specialized in back problems and practiced within the state of Pennsylvania, one could seek to get access on 2^{nd} website to credentials of all persons meeting all of these criteria. The search obviously could be refined or broadened as desired under the circumstances.

It will be appreciated, therefore, that the present invention provides an efficient, rapid and effective means for evaluation of authentication of an individual's crendentials preferably at least in part, by computer, which, if accepted, permits the individual to employ indicia of acceptance or certification in its promotional materials, including its website. In one embodiment, this permits third parties to access the authenticating agency's website 94 remotely, either through the individual's website 92, as by hyperlinking, or directly. Also, properly authorized third parties can access the authenticating agency's website to view a plurality of individuals' credentials.

While particular embodiments of the invention have been disclosed herein for purposes of illustration, it will be evident to those skilled in the art that numerous variations of the details may be made without departing from the invention as set forth in the appended claims.

1. A computerized method evaluating credentials of an individual comprising
receiving credentials relating to said individual,
obtaining from at least one third party information regarding whether said credentials are authentic,
if said credentials are authentic, approving said individual for certification of said credentials, and
permitting remote access to said credentials through a computer

2. The computerized method of claim 1 including
permitting a first website to display indicia of approval of said individual.

3. The computerized method of claim 2 including
employing a second website having a database storing said individual's authenticated credentials, and
permitting access to approved individual's credentials from a remote computer.

4. The computerized method of claim 3 including
said first website being hyperlinked to a second website.

5. The computerized method of claim 1 including
prior to accepting an individual for said validation process, obtaining said credentials from said individual, and
on the basis of said credentials, making a determination regarding whether said individual will be approved for evaluation for certification on the basis of authentication of said credentials.

6. The computerized method of claim 5 including
said authentication of said individual's credentials relate to at least one category selected from the group consisting of education, professional licenses, memberships, publications, medical records, residences, criminal records, background check, date of birth and employment history.

7. The computerized method of claim 1 including
on the basis of said information, either rejecting or approving said individual.

8. The computerized method of claim 7 including
notifying said individual of said rejection or said approval.

9. The computerized method of claim 4 including
if said individual is accepted, permitting the individual to display indicia of said acceptance.

10. The computerized method of claim 4 including
providing said hyperlink only if said individual is accepted, and
said second website permitting third parties to access said authenticated credentials of said individual remotely.

11. The computerized method of claim 1 including
said second website having a database which is accessible by third parties and permits said third parties to review credentials of a plurality of said approved individuals.

12. The computerized method of claim 4 including
permitting said approved individual to employ indicia on said first website which, when clicked on by a third party, will establish a hyperlink connection to said second website.

13. The computerized method of claim 1 including
employing said method on a plurality of natural persons within a business entity.

14. The computerized method of claim 1 including
introducing said credentials into said computer.

15. The computerized method of claim 14 including
introducing said information obtained from said third party into said computer.

16. The computerized method of claim 15 including
effecting a comparison of said credentials and said information in said computer.

17. The computerized method of claim 11 including
requiring said third parties to provide desired security identification before permitting access to said credentials.

18. The computerized method of claim 11 including
effecting said review by said third parties by searching said database.

19. The computerized method of claim 18 including
permitting said searcher to search within a single field or plurality of fields.

20. Apparatus for authenticating credentials of an individual comprising
a computer for receiving credentials relating to said individual,
said computer being structured to send inquiries regarding authenticity of said credentials to information sources and receive responses to said inquiries, and
said computer being structured to compare said responses with stored credentials of said individual and make a determination regarding whether to approve or reject said individual for certification of authenticity based upon said responses.

21. The apparatus of claim 20 including
said computer being structured to permit remote access to said credentials of said individual if said individual has been approved.

22. The apparatus of claim 20 including
said computer being structured to resist remote access to said credentials if said individual has been rejected.

23. The apparatus of claim 20 including
said computer being structured to evaluate credentials related to at least one of the group consisting of education, professional licenses, memberships, publications, medical records, residences, criminal records, background check, date of birth and employment.

24. The apparatus of claim 22 including
said remote access being through a hyperlink with another computer.

25. The apparatus of claim 22 including
said computer having a database which contains credentials of a plurality of individuals.

26. The apparatus of claim 24 including
said computer permitting access to credentials of a plurality of said approved individuals.

27. The apparatus of claim 20 including
said computer having a database for storing credentials of said individual.

28. The apparatus of claim 25 including
said computer structured to permit third party access to said credentials of said plurality of individuals only after security identification of said third party.
